(19) United States
(12) Patent Application Publication
(10) Pub. No.: US 2020/0401236 A1
(43) Pub. Date: Dec. 24, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Makoto YOSHIMI, Kanagawa (JP); Yoko TSURUMI, Kanagawa (JP)

(73) Assignee: FUJI XEROX CO., LTD., Tokyo (JP)

(21) Appl. No.: 16/683,815

(22) Filed: Nov. 14, 2019

(30) Foreign Application Priority Data
Jun. 19, 2019 (JP) 2019-114033

(51) Int. Cl. G06F 3/023; H04M 1/2745

(52) U.S. Cl. CPC G06F 3/0237; H04M 2001/274541; H04M 1/274533; H04M 1/274558

(57) ABSTRACT

An information processing apparatus includes a first acquisition unit, a second acquisition unit, and a display controller. The first acquisition unit acquires at least one candidate of first string. The at least one candidate of first string is generated by a module in accordance with a received operation. The second acquisition unit acquires candidates of second string. The candidates of second string are generated by an app in accordance with the at least one candidate of first string. When the candidates of second string satisfy a determined condition, the display controller does not cause a display unit to display the at least one candidate of first string and causes the display unit to display the candidates of second string.

### CROSS-REFERENCE TO RELATED APPLICATIONS

This application is based on and claims priority under 35 USC 119 from Japanese Patent Application No. 2019-114033 filed Jun. 19, 2019.

### BACKGROUND

### (i) Technical Field

The present disclosure relates to an information processing apparatus and a non-transitory computer readable medium.

### (ii) Related Art

Among information processing apparatuses receiving input of characters and the like from users, there is an apparatus using a module called an input method engine or the like. The module generates a string in accordance with an operation which is input by a user. For example, the module generates a phonogramic string such as a kana string in accordance with an operation of a user, and decomposes the phonogramic string into segments and refers to a dictionary to generate a string including kanji characters and the like determined in accordance with the segments. There is a module that generates a string, as described above, in accordance with an operation on the basis of a history of a user's past operations.

Various techniques have been studied, such as those of outputting a string in accordance with a user's input operation to assist the user's input operation. For example, Japanese Unexamined Patent Application Publication No. 2003-16003 describes an electronic-mail-address input method of, when a character is input, outputting, as complementary candidates, a combination of electronic mail addresses including an electronic mail address whose first character matches the input character. Japanese Unexamined Patent Application Publication No. 2007-41675 describes a destination-information input apparatus. When a given character is received, the destination-information input apparatus detects address information, which is associated with the character, from a storage unit. Then, the destination-information input apparatus causes a display unit to display the address information according to a given display order through an operation, and obtains selection and determination of desired address information from the displayed addresses.

A typical module generates, not a single string which is selected temporarily according to a received operation, but multiple individual strings as candidates in accordance with the operation. An information processing apparatus may display these candidates to receive selection performed by a user.

However, if an application program (hereinafter referred to as an app) using the module also has a function of displaying conversion candidates in accordance with the “temporarily selected string”, the candidates displayed by the module may occupy a display area, causing the conversion candidates of the app to be hidden. In contrast, if only the conversion candidates of the app are displayed, the too many conversion candidates may make it difficult to perform an operation for finding a string that is to be input.

### SUMMARY

Aspects of non-limiting embodiments of the present disclosure relate to a technique of, when an app uses first string candidates, which are generated by a module in accordance with a received operation, so as to generate second strings, displaying the second string candidates in such a manner that an operation is not hindered.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a first acquisition unit, a second acquisition unit, and a display controller. The first acquisition unit acquires at least one candidate of first string. The at least one candidate of first string is generated by a module in accordance with a received operation. The second acquisition unit acquires candidates of second string. The candidates of second string are generated by an app in accordance with the at least one candidate of first string. When the candidates of second string satisfy a determined condition, the display controller does not cause a display unit to display the at least one candidate of first string and causes the display unit to display the candidates of second string.

### BRIEF DESCRIPTION OF THE DRAWINGS

Exemplary embodiments of the present disclosure will be described in detail based on the following figures, wherein:

FIG. 1 is a diagram illustrating an exemplary configuration of an information processing apparatus;

FIG. 2 is a diagram illustrating an exemplary functional configuration of an information processing apparatus;

FIG. 3 is a diagram illustrating an exemplary table in which the name and the email address are associated with one another;

FIG. 4 is a diagram illustrating an exemplary screen displayed on a display unit of an information processing apparatus;

FIG. 5 is a diagram illustrating exemplary first string candidates for an operation on one syllable character;

FIGS. 6A to 6E are diagrams illustrating exemplary second string candidates corresponding to the first strings illustrated in FIG. 5;

FIG. 7 is a diagram illustrating exemplary first string candidates for an operation on two syllable characters;

FIGS. 8A and 8B are diagrams illustrating exemplary second string candidates corresponding to the first strings illustrated in FIG. 7;

FIG. 9 is a diagram illustrating exemplary second string candidates obtained when a first string is determined;

FIG. 10 is a diagram illustrating an exemplary operation for switching display of candidates;

FIG. 11 is a diagram illustrating an exemplary table in which the name and the email address are associated with one another;

FIGS. 12A and 12B are diagrams, each of which illustrates an exemplary screen displayed on a display unit of an information processing apparatus;

FIGS. 13A and 13B are diagrams illustrating exemplary second string candidates;

FIG. 14A is a diagram illustrating exemplary first string candidates;

FIG. 14B is a diagram illustrating exemplary first string candidates for an operation; and

FIG. 14C is a diagram illustrating exemplary second string candidates in accordance with the first strings illustrated in FIG. 14B.

### DETAILED DESCRIPTION

### Exemplary Embodiments

### Configuration of an Information Processing Apparatus

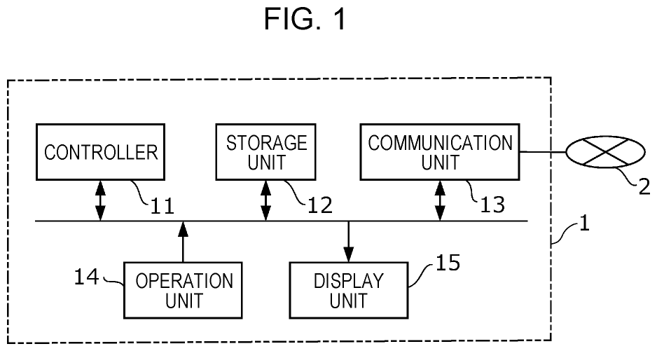

FIG. 1 is a diagram illustrating an exemplary configuration of an information processing apparatus 1. The information processing apparatus 1 illustrated in FIG. 1 includes a controller 11, a storage unit 12, a communication unit 13, an operation unit 14, and a display unit 15.

The controller 11 includes a central processing unit (CPU), a read only memory (ROM), and a random access memory (RAM). The CPU reads, for execution, computer programs (hereinafter simply referred to as programs) stored in the ROM or the storage unit 12, thus controlling the units of the information processing apparatus 1.

The communication unit 13 is a communication circuit which establishes a connection with a communication line 2 with or without wires. The information processing apparatus 1 receives/transmits information from/to external apparatuses connected to the communication line 2, by using the communication unit 13. If the information processing apparatus 1 does not need to receive/transmit information from/to external apparatuses, the information processing apparatus 1 does not necessarily include the communication unit 13.

The operation unit 14 includes operators, such as operation buttons, a keyboard, and a touch panel, for transmitting various instructions. The operation unit 14 receives an operation performed by a user and transmits, to the controller 11, a signal generated in accordance with the operation. Examples of an operation performed by a user include a keystroke on a keyboard and a gesture on a touch panel.

The display unit 15 has a display screen such as a liquid-crystal display, and displays images under control of the controller 11. A transparent touch panel of the operation unit 14 may overlie the display screen.

The storage unit 12 is a storage section, such as a solid-state drive or a hard disk drive. The storage unit 12 stores, for example, an operating system, various programs, and data which are to be read by the CPU of the controller 11.

### The Functional Configuration of the Information Processing Apparatus

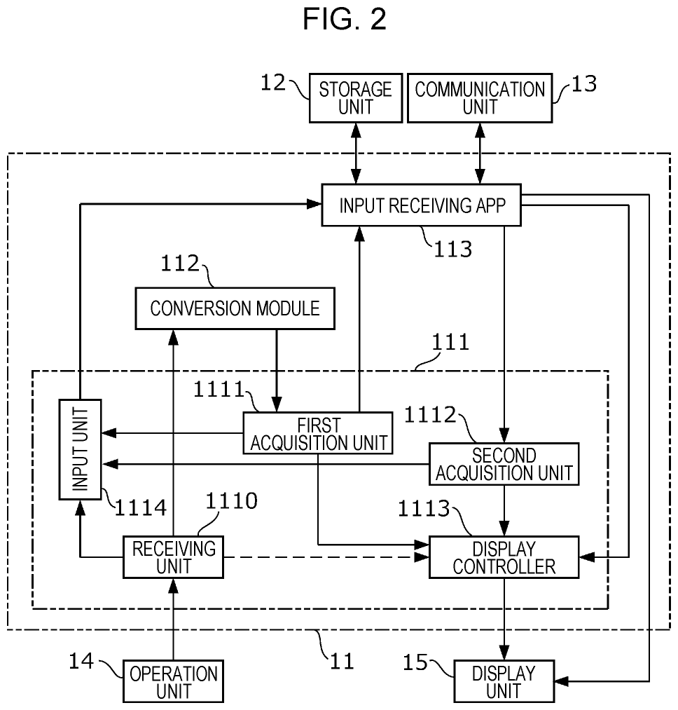

FIG. 2 is a diagram illustrating an exemplary functional configuration of the information processing apparatus 1. The controller 11 of the information processing apparatus 1 reads, for execution, an operating system from the storage unit 12. The controller 11 also reads, for execution, an input app 111, a conversion module 112, and an input receiving app 113 which are programs.

The input app 111 displays a so-called “touch keyboard”, which is a virtual keyboard, on the display unit 15, and receives an operation performed by a user on the touch keyboard. This operation is received by the touch panel of the operation unit 14. The input app 111 receives/transmits information from/to the conversion module 112 and the input receiving app 113.

The conversion module 112 refers to a dictionary to convert a phonetic transcription in kana or the like, which is indicated by an operation received by the input app 111, into strings including corresponding kanji characters or the like. Additionally or alternatively, the conversion module 112 may convert a text, which is received by the input app 111, into characters with accent mark. In addition, the conversion module 112 refers to a history of operations having been received from the user before, so as to generate strings predictive from a newly received operation. That is, the conversion module 112 is a kind of a module which generates strings (referred to as first strings) in accordance with an operation received by the information processing apparatus 1.

The input receiving app 113 performs information processing using a string supplied from the input app 111. The input receiving app 113 described below transmits electronic mail to an email address indicated by a string supplied from the input app 111.

The input receiving app 113 illustrated in FIG. 2 transmits, to the input app 111, a determined signal, for example, in its start-up. The determined signal is a signal for instructing the input app 111 to suppress display of first string candidates, which are generated by the conversion module 112, under a determined condition.

The information processing apparatus 1 stores, in the storage unit 12, a table in which the name of an electronic mail destination and the email address indicating the destination itself are associated with one another.

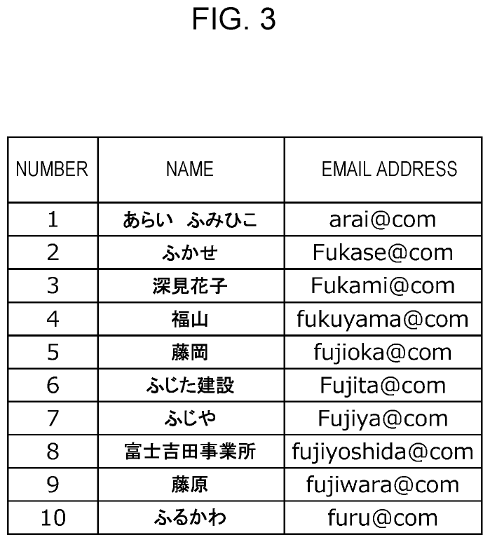

FIG. 3 is a diagram illustrating an exemplary table in which the name and the email address are associated with one another. The “number” in the table in FIG. 3 indicates an identification number assigned to each set of the name and the email address. Each set which is included in the table and which is described above is identified by using the number. The input receiving app 113 reads, for reference, the table in FIG. 3 from the storage unit 12, and predicts email addresses from a supplied first string(s).

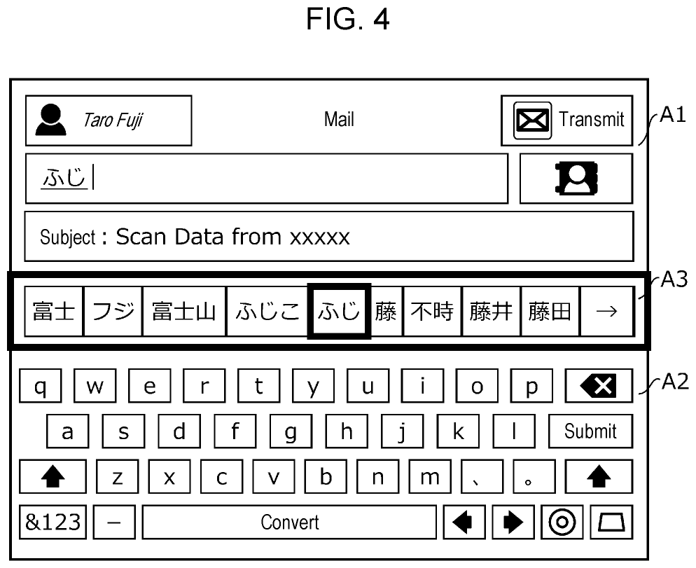

FIG. 4 is a diagram illustrating an exemplary screen displayed on the display unit 15 of the information processing apparatus 1. An area A1 is controlled by the input receiving app 113. An area A2 is controlled by the input app 111. In the area A2, a touch keyboard is displayed. An area A3 is controlled by the input app 111. In the area A3, first string candidates, which are generated by the conversion module 112 and which are arranged in the horizontal direction, are displayed to receive selection from the candidates.

The input app 111 illustrated in FIG. 2 serves as a receiving unit 1110, a first acquisition unit 1111, a second acquisition unit 1112, a display controller 1113, and an input unit 1114.

The receiving unit 1110 receives a user's operation from the operation unit 14. When the received operation indicates selection of any one of the string candidates displayed on the display unit 15, the receiving unit 1110 supplies the input unit 1114 with operation information indicating the operation. Examples of the “operation for selection of a candidate” include a tap operation in an area for indicating a candidate, and an operation of pressing a “Submit” key on a touch keyboard.

When the input unit 1114 is supplied with the operation information from the receiving unit 1110, the input unit 1114 determines the string of the candidate selected by the user, on the basis of the operation information, and inputs the determined string to the input receiving app 113. That is, the input unit 1114 is an exemplary input unit that, when an operation of selecting any one of candidates displayed on the display unit is received, inputs, to the app, a string indicated by the selected candidate.

When the received operation is not an above-described operation of selecting a candidate, the receiving unit 1110 supplies the conversion module 112 with operation information indicating the operation.

The conversion module 112 generates first string candidates on the basis of operation information supplied from the receiving unit 1110. When an operation indicated by the supplied operation information indicates, for example, pressing of keys indicating non-control characters, such as alphabetic characters or symbols, on the touch keyboard, the conversion module 112 generates the phonogram or the like corresponding to the keys. The conversion module 112 predicts a first string, which the user is going to input, on the basis of the phonogram or the like described above, the operation information, and the history of past operations of the user, and generates its candidates. The conversion mode in which first string candidates are generated through prediction is referred to as the “predictive text mode”.

When an operation indicated by the supplied operation information indicates, for example, an operation indicating an instruction to switch the conversion mode, the conversion module 112 switches the conversion mode from the “predictive text mode” described above to the “kana-kanji conversion mode”. The “kana-kanji conversion mode” is a conversion mode in which the phonogram or the like described above is used to generate first string candidates including kanji characters and the like corresponding to the phonogram or the like on the basis of a dictionary.

When the conversion mode is switched to the kana-kanji conversion mode, the conversion module 112 decomposes the phonogram or the like described above into one or more segments, for example, by using a syntactic analysis process such as morphological analysis. Then, the conversion module 112 extracts kanji characters and the like corresponding to the phonetic transcription of each segment, and generates first string candidates, in which the extracted strings are arranged in sequence.

The first acquisition unit 1111 acquires first string candidates described above from the conversion module 112. That is, the first acquisition unit 1111 is an exemplary first acquisition unit that acquires first string candidates generated by the module in accordance with a received operation.

The first acquisition unit 1111 illustrated in FIG. 2 acquires first string candidates generated by the conversion module 112, and supplies the acquired candidates to the display controller 1113. In addition, the first acquisition unit 1111 illustrated in FIG. 2 determines one first string from the one or more acquired candidates, and supplies the first string to the input receiving app 113. Determination of a first string is performed, for example, on each of the one or more candidates on the basis of the order given in accordance with past operations of the user.

The input receiving app 113 generates strings (referred to as second strings) corresponding to the supplied first string(s). The input receiving app 113 illustrated in FIG. 2 extracts data including the above-described first string(s), from the email addresses of electronic mail and the names of the destinations which are stored in the table in FIG. 3. When an email address is extracted, the input receiving app 113 determines the email address. When a name is extracted, the input receiving app 113 determines the email address corresponding to the name. Then, the input receiving app 113 generates a second string including the determined email address.

When multiple email address described above are determined, the input receiving app 113 generates a second string candidate corresponding to each email address. When no email addresses described above are determined, the input receiving app 113 does not generate a second string candidate.

The second acquisition unit 1112 acquires the described-above second string candidates generated by the input receiving app 113. That is, the second acquisition unit 1112 is an exemplary second acquisition unit that acquires second string candidates generated by the app in accordance with a first string(s). The second acquisition unit 1112 illustrated in FIG. 2 acquires second string candidates generated by the input receiving app 113, and supplies the acquired candidates to the display controller 1113.

The display controller 1113 compares, with a threshold, the number of second string candidates supplied by the second acquisition unit 1112. If the display controller 1113 determines that the number of second string candidates is less than the threshold, the display controller 1113 does not cause the display unit 15 to display the first string candidates supplied by the first acquisition unit 1111, and causes the display unit 15 to display the second string candidates. The display controller 1113 is an exemplary display controller that, when the number of second string candidates is less than the threshold, does not cause the display unit to display the first string candidates and causes the display unit to display the second string candidates.

If the display controller 1113 determines that the number of second string candidates is equal to or greater than the threshold from the comparison result described above, the display controller 1113 controls the display unit 15 so that the second string candidates are not displayed. The display controller 1113 is an exemplary display controller that, when the number of second string candidates is equal to or greater than the threshold, does not cause the display unit to display the second string candidates.

The display controller 1113 illustrated in FIG. 2 receives the above-described signal from the input receiving app 113 upon a start-up or the like of the input receiving app 113. If the signal is received and if it is determined that the number of second string candidates is less than the threshold, the display controller 1113 causes the display unit 15 to display the second string candidates. That is, the display controller 1113 is an exemplary display controller that, when a determined signal is received from the app and if second string candidates satisfy a determined condition, does not cause the display unit to display first string candidates and causes the display unit to display the second string candidates.

### Operations of the Information Processing Apparatus

When a user operates the operation unit 14 of the information processing apparatus 1 to start the information processing apparatus 1, the controller 11 reads, for execution, an operating system from the ROM or the storage unit 12. Then, the controller 11 reads, for execution, the input app 111 and the conversion module 112, for example, from the storage unit 12 on the basis of an instruction from the operating system.

The input app 111 displays, for example, the touch keyboard illustrated in FIG. 4, and receives an operation of the user in each area included in the touch keyboard. The conversion module 112 starts reception/transmission of information from/to the input app 111.

When the user operates the operation unit 14 to give an instruction to start the input receiving app 113, the controller 11 reads, for execution, the input receiving app 113 from the storage unit 12. The input receiving app 113 transmits the above-described signal to the input app 111 upon the start-up, and constructs a display area specific to the display unit 15. The area A1 illustrated in FIG. 4 is an exemplary display area specific to the input receiving app 113. The touch keyboard is displayed by the input app 111 so as to overlie the display area specific to the input receiving app 113.

When the user operates the operation unit 14 to press, for example, a key indicating a non-control character among the keys included in the touch keyboard displayed on the display unit 15, in response to the operation, the input app 111 supplies the conversion module 112 with operation information indicating the operation. Then, the input app 111 acquires, from the conversion module 112, first string candidates in accordance with the above-described operation.

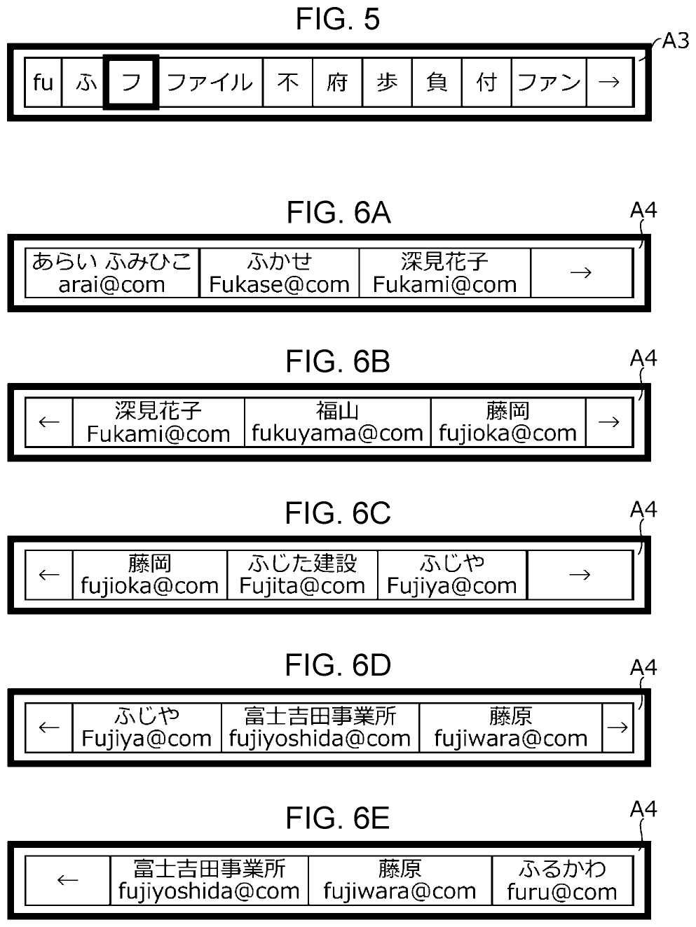

FIG. 5 is a diagram illustrating exemplary first string candidates for an operation on one syllable character. For example, the input app 111 holds a setting for receiving input of Japanese Roman letters. When the user performs an operation of touching “f” and “u” in this order on the touch keyboard, the operation is received by the receiving unit 1110 of the input app 111 and is supplied to the conversion module 112.

The conversion module 112 generates the phonogram “ [symbol] ” from the above-described operation on the basis of a Japanese Roman letter input process. That is, a single hiragana character “ [symbol] ” is generated from the two key inputs of “f” and “u”. The conversion module 112 generates first string candidates in accordance with the “ [symbol] ” through predictive text function or kana-kanji conversion.

The first acquisition unit 1111 acquires the first string candidates from the conversion module 112. The display controller 1113 receives the first string candidates, and generates an image of the area A3 illustrated in FIG. 5. In the area A3, “fu”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ” and the like are obtained as first string candidates.

The first acquisition unit 1111 supplies the input receiving app 113 with the first string candidates. The input receiving app 113 generates second string candidates in accordance with the supplied first string candidates. The input receiving app 113 uses the first string candidates illustrated in FIG. 5, so as to extract, from the name field and the email address field in the table illustrated in FIG. 3, data including “fu”, “ [symbol] ”, “ [symbol] ”, “ [symbol] ”, “ [symbol] ”, “ [symbol] ”, “ [symbol] ”, “ [symbol] ”, “ [symbol] ”, or “ [symbol] ”. Then, the input receiving app 113 determines the extracted email addresses or email addresses corresponding to the extracted names, and generates second string candidates including the determined email addresses.

FIGS. 6A to 6E are diagrams illustrating exemplary second string candidates in accordance with the first strings illustrated in FIG. 5. In display of second string candidates on the display unit 15, the display controller 1113 arranges the second string candidates in the horizontal direction, and displays the candidates on the area A3 described above. The area in which second string candidates are displayed is called an area A4. When the area A4 is displayed, the receiving unit 1110 receives selection from the second string candidates included in the area A4. When the area A4 is displayed, the area A3 is hidden by the area A4 and is not displayed. The receiving unit 1110 does not receive selection of the first string candidates included in the area A3.

In the name field and the email address field in the table illustrated in FIG. 3, all of the data (that is, the ten sets) from the number “1” to the number “10” includes “fu”, “ [symbol] ”, or “ [symbol] ”. Accordingly, when the input app 111 is to display the second string candidates, the input app 111 has to display the ten sets in the area A4. However, the size of the area A4 is limited. Thus, the display unit 15 is not able to display all of the ten sets at a time. Accordingly, if the input app 111 is to display the second string candidates at this stage, for example, the input app 111 divides the second string candidates into five sections illustrated in FIGS. 6A to 6E, and displays each of the five sections at a time in the area A4.

At that time, the display controller 1113 determines whether or not the second string candidates satisfy a determined condition. In the exemplary embodiment, the display controller 1113 determines whether or not the number of second string candidates is less than the threshold. If the display controller 1113 determines that the number of second string candidates is less than the threshold as described above, the display controller 1113 causes the display unit 15 to display the second string candidates. If the display controller 1113 determines that the number of second string candidates is equal to or greater than the threshold, the display controller 1113 does not cause the display unit 15 to display the second string candidates.

The threshold with which the display controller 1113 compares the number of second string candidates is, for example, three. In this case, the number of second string candidates is ten. Accordingly, the display controller 1113 determines that the number of candidates is equal to or greater than the threshold. Thus, the display controller 1113 controls the display unit 15 so that the second string candidates are not displayed. The display unit 15 does not display the area A4 illustrated in FIG. 6A to 6E, and displays the area A3 illustrated in FIG. 5.

Subsequently, when the user performs an operation of touching “j” and “i” in this order on the touch keyboard, the operation is also received by the receiving unit 1110 of the input app 111, and operation information indicating the operation is supplied to the conversion module 112.

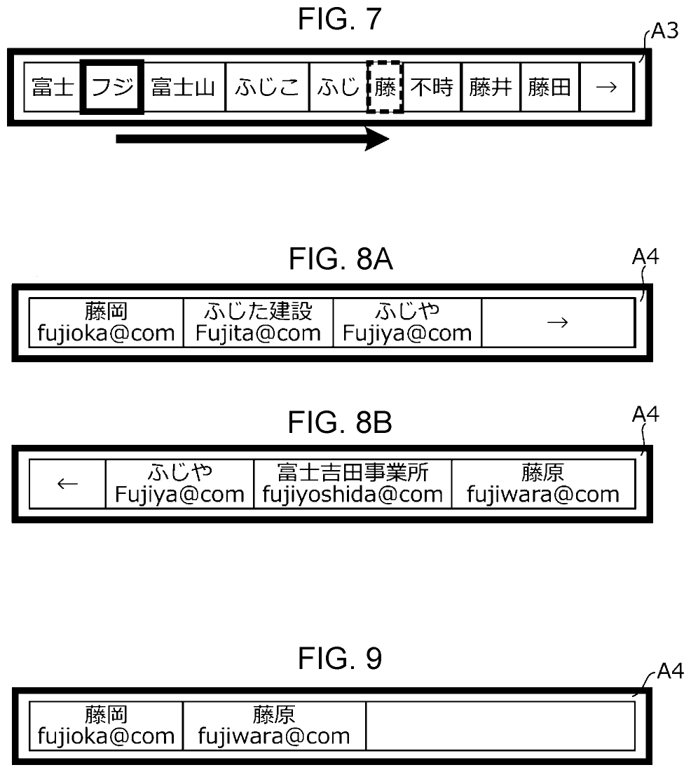

FIG. 7 is a diagram illustrating exemplary first string candidates for the operation on two syllable characters. As described above, when the user performs an operation of touching “j” and “i” in this order subsequent to an operation of touching “f” and “u”, the conversion module 112 generates the phonogram “ [symbol] ” from the series of operations described above. That is, two hiragana characters “ [symbol] ” are generated from the four key inputs of “f”, “u”, “j”, and “i”. The conversion module 112 generates first string candidates in accordance with “ [symbol] ” through predictive text function or kana-kanji conversion.

At that time, the first string candidates are “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, and the like as in the area A3 illustrated in FIG. 7. At that time, the conversion module 112 also generates “fuji” which indicates the key inputs themselves and which is included in the first string candidates.

The input receiving app 113 extracts, from the name field and the email address field of the table illustrated in FIG. 3, data including the first string candidates. The input receiving app 113 generates second string candidates each including an extracted name or email address.

FIGS. 8A and 8B are diagrams illustrating exemplary second string candidates in accordance with the first strings illustrated in FIG. 7. The five sets from the number “5” to the number “9” in the name field in the table in FIG. 3 include the first string candidates (for example, “fuji”, “ [symbol] ”, “ [symbol] ”, “ [symbol] ”, and the like). At that time, the number of second string candidates decreases from ten to five. However, due to the limitation of the size of the area A4, the display unit 15 fails to display all of the five sets at a time. Accordingly, if the input app 111 is to display the second string candidates at this stage, for example, the input app 111 has to divide the second string candidates into two sections illustrated in FIGS. 8A and 8B, and displays each of the two sections at a time in the area A4.

The display controller 1113 compares the number of second string candidates, that is, five, with the threshold, that is, three, and determines that the number of candidates is equal to or greater than the threshold. Thus, also at this stage, the area A4 in FIGS. 8A and 8B is not displayed on the display unit 15, and the area A3 in FIG. 7 is displayed.

When the user performs an operation of selecting any one of the first string candidates displayed in the area A3 illustrated in FIG. 7, for example, the bold frame indicating the determined candidate moves in accordance with the operation.

When the user performs an operation, such as flicking or swiping, for example, along the arrow illustrated in FIG. 7 on the area A3 displayed on the display unit 15, the bold frame indicating the selected first string moves to the position indicated by the broken line in FIG. 7. Then, for example, when the user performs an operation such as pressing the “Submit” key on the touch keyboard and gives an instruction to determine the first string indicated by using the bold frame, in response to the operation, the controller 11 of the information processing apparatus 1 determines “ [symbol] ” among the first string candidates in FIG. 7, as a new first string.

FIG. 9 is a diagram illustrating exemplary second string candidates obtained when the first string is determined. When “ [symbol] ” is determined to be the first string, the input receiving app 113 extracts, from the name field and the email address field in the table in FIG. 3, data including “ [symbol] ”.

The two sets of the number “5” and the number “9” in the name field and the email address field in the table in FIG. 3 include “ [symbol] ”. At that time, the display controller 1113 compares the number of second string candidates, that is, two, with the threshold, that is, three, and determines that the number of candidates is less than the threshold. Thus, the display controller 1113 controls the display unit 15 so that the second string candidates are displayed. The display unit 15 displays the area A4 in FIG. 9 so that the area A4 overlies the area A3 in FIG. 7. As a result, the area A3 in FIG. 7 is not displayed on the display unit 15, and the area A4 in FIG. 9 is displayed.

As described above, in the information processing apparatus 1 provided by the present disclosure, when the input receiving app 113 generates second string candidates in accordance with first string candidates, the second string candidates are not displayed, for example, until a condition such as “the number of candidates is less than a threshold” is satisfied. Thus, display of second string candidates does not hinder an operation.

### Modified Examples

The exemplary embodiment is described above. The exemplary embodiment may be modified as described below. The modified examples described below may be combined with each other.

<1>

In the exemplary embodiment described above, when the display controller 1113 determines that the number of second string candidates is less than the threshold, the display controller 1113 does not cause the display unit 15 to display first string candidates supplied by the first acquisition unit 1111, and causes the display unit 15 to display second string candidates. However, the condition for displaying second string candidates is not limited to this. For example, when all second string candidates are capable of being displayed at a time in the area A4 described above, the display controller 1113 may exert control so that the second string candidates are displayed.

When the number of operations necessary to display all second string candidates in the area A4 is less than a threshold, the display controller 1113 may exert control so that the second string candidates are displayed. That is, when second string candidates satisfy a determined condition, the display controller 1113 does not cause the display unit to display first string candidates, and may cause the display unit to display the second string candidates. When second string candidates do not satisfy the condition, the display controller 1113 does not cause the display unit to display the second string candidates.

<2>

In the exemplary embodiment described above, the display controller 1113 receives the signal from the input receiving app 113 at a start-up of the input receiving app 113. However, the display controller 1113 does not necessarily receive the signal. In addition, regardless of whether or not the signal has been received, when the display controller 1113 determines that second string candidates satisfy a determined condition, the display controller 1113 may cause the display unit 15 to display the second string candidates. That is, the display controller 1113 may be a display controller that, when second string candidates satisfy the determined condition, causes the display unit to display the second string candidates, not first string candidates.

<3>

In the exemplary embodiment described above, Japanese text input is used as an example. However, the present disclosure is applicable to English or other language text input as well.

When a user performs an operation of touching “b” and “e” in this order on the touch keyboard, the operation is also received by the receiving unit 1110 of the input app 111, and operation information indicating the operation is supplied to the conversion module 112.

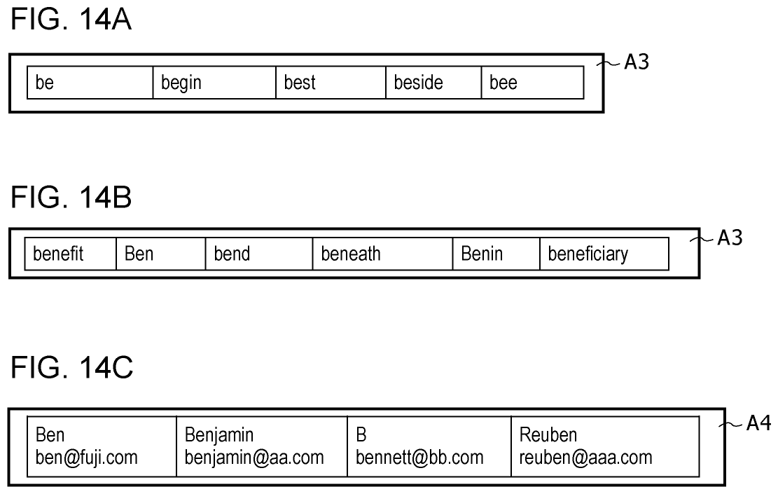

FIG. 14A is a diagram illustrating exemplary first string candidates. As described above, when the user performs an operation of touching “b” and “e” in this order, the conversion module 112 generates first string candidates in accordance with “be” through predictive text function.

At that time, the first string candidates “be”, “begin”, “best”, “beside”, “bee”, and the like are displayed in the area A3 illustrated in FIG. 14A.

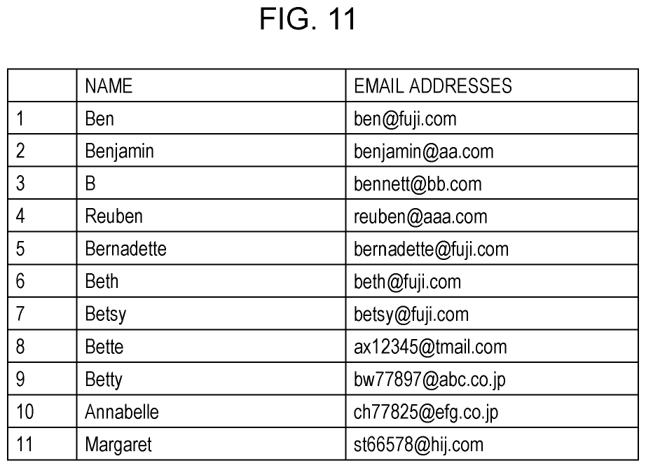

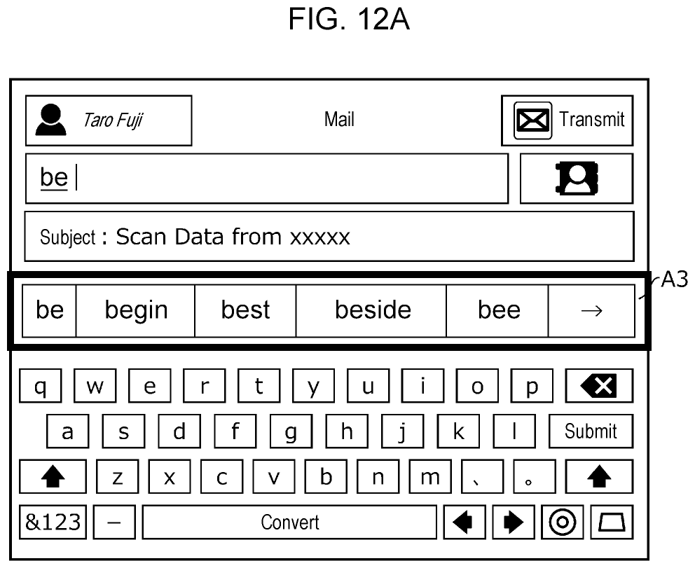

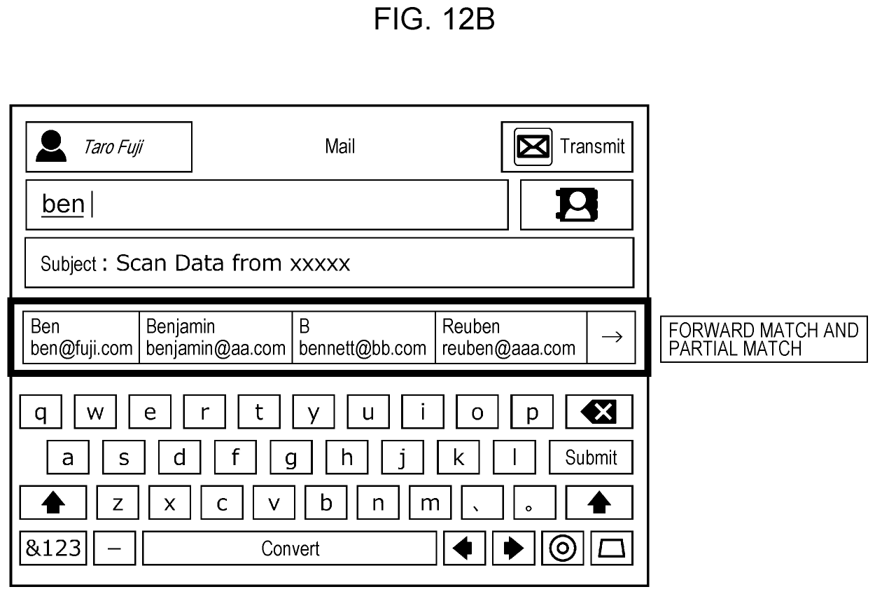

The input receiving app 113 extracts, from the name field and the email address field of the table illustrated in FIG. 11, data including any of the first string candidates. The input receiving app 113 generates second string candidates each including an extracted name or email address.

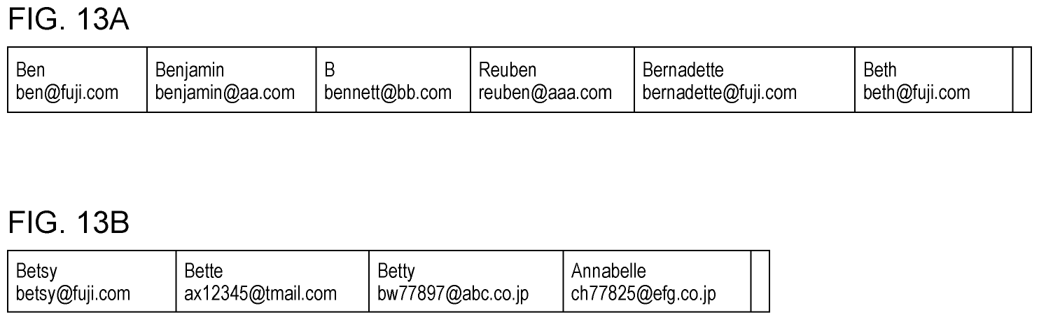

FIG. 13A and FIG. 13B are diagrams illustrating exemplary second string candidates. The ten sets from the number “1” to the number “10” in the name field and the email address in the table in FIG. 11 include “be”, which is one of the first string candidates. However, because the size of the area A4 is limited, the display unit 15 divides the second string candidates into two sections as illustrated in FIGS. 13A and 13B. The threshold with which the display controller 1113 compares the number of second string candidates is, for example, five. In this case, the number of second string candidates is ten. Accordingly, the display controller 1113 determines that the number of second candidates is equal to or greater than the threshold. Thus, the display controller 1113 controls the display unit 15 so that the second string candidates are not displayed. At that time, the first string candidates “be”, “begin”, “best”, “beside”, “bee” and the like are displayed in the area A3 as illustrated in FIG. 14A.

Subsequently, when the user performs an operation of touching “b”, “e” and “n” in this order on the touch keyboard, the operation is also received by the receiving unit 1110 of the input app 111, and operation information indicating the operation is supplied to the conversion module 112.

FIG. 14B is a diagram illustrating exemplary first string candidates for the operation. As described above, when the user performs an operation of touching “n” subsequent to an operation of touching “b” and “e”, the conversion module 112 generates first string candidates in accordance with “ben” through predictive text function from the series of operations described above. In this case, the first string candidates includes “ben”.

Next, the input receiving app 113 extracts, from the name field and the email address field of the table illustrated in FIG. 11, data including the first string candidates. The input receiving app 113 generates second string candidates each including an extracted name or email address.

FIG. 14C is a diagram illustrating exemplary second string candidates in accordance with the first strings illustrated in FIG. 14B. The four sets from the number “1” to number “4” in the name field and the email address field in the table in FIG. 11 include “ben”. At that time, the display controller 1113 compares the number of second string candidates, that is, four, with the threshold, that is, five, and determines that the number of candidates is less than the threshold. Thus, the display controller 1113 controls the display unit 15 so that the second string candidates are displayed. The display unit 15 displays the area A4 in FIG. 14C so that the area A4 overlies the area A3 in FIG. 14B. As a result, the area A3 in FIG. 14B is not displayed on the display unit 15, and the area A4 in FIG. 14C is displayed.

<4>

In the exemplary embodiment described above, when the display controller 1113 does not cause the display unit 15 to display second string candidates, the display controller 1113 causes the display unit 15 to display supplied first string candidates. However, first string candidates may be displayed by using the conversion module 112, or by using a different app or the like which collaborates with the conversion module 112. Examples of the different app collaborating with the conversion module 112 includes an app called a renderer or the like. The renderer obtains, for display, first string candidates from the conversion module 112, and receives an operation of selecting from these candidates. In this case, in accordance with whether or not second string candidates satisfy a determined condition, the display controller 1113 may instruct the conversion module 112, the renderer, or the like to display or not display first string candidates. In this case, the first acquisition unit 1111 does not necessarily supply the display controller 1113 with first string candidates obtained from the conversion module 112.

<5>

In the exemplary embodiment described above, the display controller 1113 obtains second string candidates from the second acquisition unit 1112. When the display controller 1113 determines that the number of second string candidates is less than the threshold, the display controller 1113 causes the second string candidates to be displayed. Alternatively, second string candidates may be displayed by the input receiving app 113. In this case, in accordance with whether or not second string candidates satisfy a determined condition, the display controller 1113 may instruct the conversion module 112 to display or not display first string candidates.

In this case, for example, the display controller 1113 may obtain, from the input receiving app 113, information about the number of second string candidates, not the second string candidates themselves. Alternatively, the input receiving app 113 may determine whether or not second string candidates satisfy a determined condition, and the display controller 1113 may obtain the determination result from the input receiving app 113.

<6>

When the receiving unit 1110 receives an operation for switching display of candidates displayed on the display unit 15, the receiving unit 1110 may supply the display controller 1113 with operation information indicating the operation. When the display controller 1113 obtains, from the receiving unit 1110, the operation information indicating an operation for switching display of candidates, in response to this, the display controller 1113 may instruct the display unit 15 to switch the display of candidates. Thus, for example, when the operation described above is received when first string candidates are being displayed, the information processing apparatus 1 displays second string candidates.

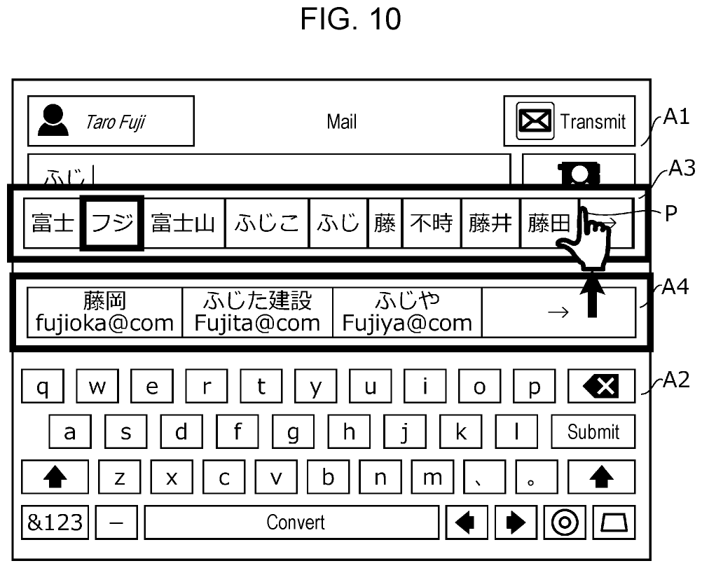

FIG. 10 is a diagram illustrating an exemplary operation for switching display of candidates. Assume the case in which the display screen in FIG. 4 is displayed on the display unit 15. When a user touches the portion P indicating the area A3 with their finger or the like, and moves their finger upward, the touch panel of the operation unit 14 detects the position at which the user's finger touches and the position of the move destination, and notifies the controller 11 of these positions. The controller 11 moves the position, at which the area A3 is drawn, on the basis of the notified positions. As a result, as illustrated in FIG. 10, the area A3 moves in accordance with the move of the finger, and the area A4 is displayed at the position at which the area A3 has been displayed. That is, the display controller 1113 implemented by the controller 11 serves as a display controller that causes the display unit to display second string candidates in the case where first string candidates are being displayed on the display unit, when an operation for switching the display of candidates is received.

In the case where second string candidates are being displayed, when the above-described operation is received, the information processing apparatus 1 displays first string candidates. For example, when a position at which the area A4 is displayed is touched with a user's finger and the finger slides and moves on the display screen on the display unit 15, the display controller 1113 obtains, from the receiving unit 1110, operation information indicating the operation, and moves the position at which the area A4 is drawn. As a result, the area A3 is displayed at the position at which the area A4 has been displayed before the move. In this case, the display controller 1113 serves a display controller that causes the display unit to display first string candidates in the case where second string candidates are being displayed on the display unit, when an operation for switching the display of candidates is received.

<7>

A program executed by the controller 11 of the information processing apparatus 1 may be provided in such a manner that the program is stored in a computer-readable recording medium, for example, a magnetic recording medium, such as a magnetic tape or a magnetic disk, an optical recording medium such as an optical disk, a magneto-optical recording medium, or a semiconductor memory. Alternatively, the program may be downloaded through a communication line such as the Internet. As a controller exemplified by the controller 11 described above, for example, various apparatuses and processors are used in addition to the CPU.

The processors indicate processors in a broad sense, and include a general-purpose processor (for example, the CPU described above) and a dedicated processor (for example, a graphics processing unit (GPU), an application specific integrated circuit (ASIC), a field programmable gate array (FPGA), or a programmable logic device).

Operations of a processor in the exemplary embodiments may indicate not only those performed by a single processor but also those performed through collaboration between multiple processors located at physical distances. The order of the operations of a processor is not limited to the order described in the exemplary embodiments. The order may be changed appropriately. That is, the information processing apparatus 1 described above may be expressed as described below.

An information processing apparatus includes one or more processors. The processors obtain first string candidates which are generated by a module in accordance with a received operation. The processors obtain second string candidates which are generated by an app in accordance with the first string candidates. When the second string candidates satisfy a determined condition, the processors do not cause a display unit to display the first string candidates, and cause the display unit to display the second string candidates.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a first acquisition unit that acquires at least one candidate of first string, the at least one candidate of first string being generated by a module in accordance with a received operation;
a second acquisition unit that acquires candidates of second string, the candidates of second string being generated by an app in accordance with the at least one candidate of first string; and
a display controller that, when the candidates of second string satisfy a determined condition, does not cause a display unit to display the at least one candidate of first string and causes the display unit to display the candidates of second string.

2. The information processing apparatus according to claim 1,
wherein, when a number of candidates of second string is less than a threshold, the display controller does not cause the display unit to display the at least one candidate of first string and causes the display unit to display the candidates of second string.

3. The information processing apparatus according to claim 1,
wherein, when a number of candidates of second string is equal to or greater than a threshold, the display controller does not cause the display unit to display the candidates of second string.

4. The information processing apparatus according to claim 2,
wherein, when the number of candidates of second string is equal to or greater than the threshold, the display controller does not cause the display unit to display the candidates of second string.

5. The information processing apparatus according to claim 1,
wherein, in a case where the at least one candidate of first string is being displayed on the display unit, when an operation for switching the display of the at least one candidate is received, the display controller causes the display unit to display the candidates of second string.

6. The information processing apparatus according to claim 2,
wherein, in a case where the at least one candidate of first string is being displayed on the display unit, when an operation for switching the display of the at least one candidate is received, the display controller causes the display unit to display the candidates of second string.

7. The information processing apparatus according to claim 3,
wherein, in a case where the at least one candidate of first string is being displayed on the display unit, when an operation for switching the display of the at least one candidate is received, the display controller causes the display unit to display the candidates of second string.

8. The information processing apparatus according to claim 4,
wherein, in a case where the at least one candidate of first string is being displayed on the display unit, when an operation for switching the display of the at least one candidate is received, the display controller causes the display unit to display the candidates of second string.

9. The information processing apparatus according to claim 1,
wherein, in a case where the candidates of second string are being displayed on the display unit, when an operation for switching the display of the candidates is received, the display controller causes the display unit to display the at least one candidate of first string.

10. The information processing apparatus according to claim 2,
wherein, in a case where the candidates of second string are being displayed on the display unit, when an operation for switching the display of the candidates is received, the display controller causes the display unit to display the at least one candidate of first string.

11. The information processing apparatus according to claim 3,
wherein, in a case where the candidates of second string are being displayed on the display unit, when an operation for switching the display of the candidates is received, the display controller causes the display unit to display the at least one candidate of first string.

12. The information processing apparatus according to claim 4,
wherein, in a case where the candidates of second string are being displayed on the display unit, when an operation for switching the display of the candidates is received, the display controller causes the display unit to display the at least one candidate of first string.

13. The information processing apparatus according to claim 5,
wherein, in a case where the candidates of second string are being displayed on the display unit, when an operation for switching the display of the candidates is received, the display controller causes the display unit to display the at least one candidate of first string.

14. The information processing apparatus according to claim 6,
wherein, in a case where the candidates of second string are being displayed on the display unit, when an operation for switching the display of the candidates is received, the display controller causes the display unit to display the at least one candidate of first string.

15. The information processing apparatus according to claim 7,
wherein, in a case where the candidates of second string are being displayed on the display unit, when an operation for switching the display of the candidates is received, the display controller causes the display unit to display the at least one candidate of first string.

16. The information processing apparatus according to claim 8,
wherein, in a case where the candidates of second string are being displayed on the display unit, when an operation for switching the display of the candidates is received, the display controller causes the display unit to display the at least one candidate of first string.

17. The information processing apparatus according to claim 1, further comprising:
an input unit,
wherein the at least one candidate of first string comprises a plurality of candidates of first string, and
wherein, when an operation of selecting any one of the candidates displayed on the display unit is received, the input unit inputs, to the app, the first string or the second string indicated by the selected candidate.

18. The information processing apparatus according to claim 1,
wherein, when a determined signal is received from the app and the candidates of second string satisfy the condition, the display controller does not cause the display unit to display the at least one candidate of first string and causes the display unit to display the candidates of second string.

19. A non-transitory computer readable medium storing a program causing a computer to execute a process, the computer including a display unit, the process comprising:
acquiring at least one candidate of first string, the at least one candidate of first string being generated by a module in accordance with a received operation;
acquiring candidates of second string, the candidates of second string being generated by an app in accordance with the at least one candidate of first string; and
when the candidates of second string satisfy a determined condition, causing the display unit not to display the at least one candidate of first string and causing the display unit to display the candidates of second string.

20. An information processing apparatus comprising:
means for acquiring at least one candidate of first string, the at least one candidate of first string being generated by a module in accordance with a received operation;
means for acquiring candidates of second string, the candidates of second string being generated by an app in accordance with the at least one candidate of first string; and
means for, when the candidates of second string satisfy a determined condition, causing a display unit not to display the at least one candidate of first string and causing the display unit to display the candidates of second string.
